(19) United States
(12) Patent Application Publication
(10) Pub. No.: US 2009/0164097 A1
(43) Pub. Date: Jun. 25, 2009

(54) INTAKE CONTROLLER FOR INTERNAL COMBUSTION ENGINE

(75) Inventor: Toshiaki UDA, Nishikamo-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/335,887

(22) Filed: Dec. 16, 2008

(30) Foreign Application Priority Data
Dec. 21, 2007 (JP) 2007-329572

(51) Int. Cl. F02D 41/18

(52) U.S. Cl. 701/103; 123/184.55

(57) ABSTRACT

At the time of supplying power to a coil of a motor in an intake vortex generating device, an AD taking-in timing of an output signal of a valve position sensor is synchronized with a power supply start timing to the motor in the PWM period of the PWM signal applied to an H-bridge circuit. The output signal of the valve position sensor is taken in only during an OFF-period of power supply in the PWM period. An actual valve position of TCV is detected from an A/D conversion value of the output of the valve position sensor taken in during an OFF-period of the power supply in the PWM period where the output variation of the valve position sensor is small. Therefore, an actual valve position of TCV can be accurately detected regardless of presence/absence of the power supply to the coil of the motor.

### CROSS-REFERENCE TO RELATED APPLICATION

This application is based on Japanese Patent Application No. 2007-329572 filed on Dec. 21, 2007, the disclosure of which is incorporated herein by reference.

### FIELD OF THE INVENTION

The present invention relates to an intake controller for an internal combustion engine provided with an intake passage-opening/closing device for opening/closing an intake passage communicated with a combustion chamber in the internal combustion engine. In particular, the present invention relates to an intake controller for an internal combustion engine provided with an intake vortex generating device to generate an intake vortex in a combustion chamber for the internal combustion engine.

### BACKGROUND OF THE INVENTION

Conventionally, an intake vortex generating device is known as an intake controller for an internal combustion engine. This intake vortex generating device throttles a passage cross section area of an intake passage communicated with a combustion chamber in the internal combustion engine to generate a turning flow (intake vortex) such as a swirl flow or a tumble flow of an air-fuel mixture in the combustion chamber in the engine, thus improving a combustion efficiency (refer to JP-2000-073843A and JP-2001-329848A (U.S. Pat. No. 6,581,566B2)). This intake vortex generating device is provided with a duct forming the intake passage in the engine, an intake flow control valve (a swirl control valve: SCV or a tumble generating valve: TGV) for opening/closing the intake passage and a rotational shaft supporting a valve body of the intake flow control valve.

A motor is connected to the intake flow control valve for driving the rotational shaft of the valve. The motor is energized and controlled based upon an operating condition of the engine such as an intake air quantity, an engine speed and a throttle valve position, and an intake flow control valve position by a control unit. The intake vortex generating device generally controls the motor with power supply as follows. At engine starting or at engine idling, the valve position is made to be in a state of a fully closed opening where the intake flow control valve is fully closed to generate a turning flow (tumble flow or swirl flow) in the combustion chamber. At normal engine operating, the valve position is made to be in a state of a fully open opening where the intake flow control valve is fully opened to make intake air go straight in the intake passage, thereby stopping generation of the turning flow.

There is well known an electronic throttle controller for an internal combustion engine to control a throttle valve as follows. When an ignition switch turns ON, the throttle valve is brought into contact with a fully-closed-position stopper to learn the fully closed position as a reference position from an output signal of a throttle position sensor. A drive duty ratio of a DC motor is controlled by PID control so that an actual throttle position is equal to a target throttle position set based upon an accelerator pedal position or the like, on a basis of the fully closed position during engine operating (refer to Japanese Patent No. 3562938).

In such an electronic throttle controller, the fully closed position learning value of the throttle position sensor may be shifted to a position more closed than an actual fully closed position due to an individual component difference or an assembly error. In this case, when the target throttle position is set to the fully closed position, even after the throttle valve is brought into a contact with the fully-closed-position stopper, the throttle valve continues to be driven to the closed side by PID control or the like. However, after the throttle valve comes to the fully closed position, even if the throttle valve continues to be driven to the closer side, a deviation between the actual throttle position and the target throttle position is not reduced any more. Therefore, the drive duty ratio of the motor is rapidly increased to the maximum duty ratio (duty ratio of 100%), possibly damaging wires of the motor with heat. For preventing a failure of the motor, when the event that the drive duty ratio of the motor is 100% continuously occurs for more than a predetermined time, it is determined that the failure of the motor occurs.

In the intake vortex generating device described in each of JP-2000-073843A and JP-2001-329848A, however, the valve body of SCV or TGV is installed in the intake passage in which an intake vacuum and an atmospheric pressure are repeatedly generated due to the reciprocation of a piston in the engine and the opening/closing of the intake valve. That is, the intake pulsation torque caused by the reciprocation of the piston and the opening/closing of the intake valve exerts on the valve body of SCV or TGV installed in the intake passage.

When the intake vacuum exerts on the valve body of SCV or TGV at the fully closed position, load torque (bending moment) is applied to the valve body in a valve-opening direction around a rotational shaft of the valve body. Therefore, it is difficult to maintain the valve body of SCV or TGV in a state of the fully closed position. When the intake pulsation exerts on the valve body of SCV or TGV at the fully open position, load torque (bending moment) is applied to the valve body in a valve-closing direction around the rotational shaft of the valve body. Therefore, it is difficult to maintain the valve body of SCV or TGV in a state of the fully open position. This phenomenon more remarkably appears in a case of using a cantilever type valve as the valve where the rotational shaft is shifted to one side in a valve-face direction from the valve central portion, as compared to a case of using a shaft-centered valve as the valve where the rotational shaft is installed in the valve central portion.

Therefore, for maintaining the fully closed position or the fully open position of the valve body during engine operating, there is proposed an intake vortex generating device as described below. In the intake vortex generating device, the motor connected to the rotational shaft of the valve body continues to be driven by low torque even after the valve is rotated to the fully open position or the fully closed position, thus controlling the rotational shaft of the valve body to be securely held to the fully open position or the fully closed position (refer to JP-2002-266647A). The intake vortex generating device is configured to detect a rotational angle (position) of the valve body for performing a fully-closing holding control for holding the fully closed state of the valve body and a fully-opening holding control for holding the fully open state of the valve body.

As the intake controller for the internal combustion engine with a valve position sensor, there is, as shown in FIG. 14, known an intake vortex generating device. The intake vortex generating device is provided with a casing (intake pipe) 102 in which an intake passage 101 of the engine is formed, an intake flow control valve (TCV) which throttles a passage cross section area of the intake passage 101 to generate a tumble flow in the combustion chamber, a rotational shaft 104 supporting a valve body 103 of TCV and an actuator for driving the valve body 103 through the shaft 104 (refer to JP-2007-068378A).

The actuator shown in FIG. 14 is comprised of a motor 105, a worm gear 111, a helical gear 112, a flexible member 113, an output spur gear 114, an input spur gear 115 and the like. A valve position sensor of a non-contact type (magnetic sensor) is mounted in the actuator for detecting a valve position of TCV. The valve position sensor is includes a magnet 116 retained and fixed in the input spur gear 115, a pair of yokes arranged as opposed to the magnet 116 and magnetized by a magnetic force of the magnet 116, a Hall IC 117 arranged in a magnetic detection gap formed between the opposing yokes, and the like. A fully open stopper 119 is provided to be capable of contacting the input spur gear 115.

In the intake vortex generating device described in each of JP-A-2002-266647 and JP-A-2007-068378, however, when the motor 105 is energized even after the valve 103 is rotated to the fully open position or the fully closed position, a magnetic field in the circumference of the valve position sensor (Hall IC 117) changes to vary the output of the valve position sensor. Therefore, a detection accuracy of the valve position sensor deteriorates. In consequence, in a case of adopting the reference position learning (fully-closed position learning) described in Japanese patent No. 3562938 for the intake vortex generating device described in each of JP-2002-266647A and JP-2007-068378A, when the target valve position is set to the fully closed position, even after the valve body of TCV is positioned at the fully closed position, the valve body continues to be driven to the closed side by a drive force of the motor. The drive duty ratio to the motor is rapidly increased to a duty ratio of 100% and this state continues to occur for more than a predetermined time period. Therefore, there is the possibility that it is detected in error (diagnosed in error) that the valve position sensor is abnormal (defective).

### SUMMARY OF THE INVENTION

The present invention is made in view of the foregoing problem and an object of the present invention is to provide an intake controller for an internal combustion engine which can accurately detect a valve position regardless of presence/absence of power supply to a motor. Another object of the present invention is to provide an intake controller which can prevent erroneous learning of a reference position on control. Another object of the present invention is to provide an intake controller which can prevent that a normal sensor is diagnosed in error to be abnormal (defective).

According to an aspect of the present invention, an intake controller for an internal combustion engine is constructed so that at the time of supplying the power to a motor, a taking-in timing of output of the motor is set close to an integral multiple of a power supply start timing to the motor. The output of the sensor is taken only during an OFF-period of power supply in a pulse signal generation period. In consequence, since the valve position is detected from the sensor output which is taken in during the OFF-period of the power supply where the output variation of the sensor including a non-contact magnetic detection element is small, the valve position can be accurately detected regardless of presence/absence of the power supply to the motor.

According to another aspect of the present invention, an intake controller for an internal combustion engine is configured so that at the time of supplying the power to a motor, the output of a sensor taken in during an ON-period of power supply in a pulse signal generation period is ignored.

In consequence, even in a case that the power is continuously supplied to the motor even after a valve is driven to a reference position whereby the magnetic field in the circumference of the sensor is changed to vary the output of the sensor, the sensor output taken in during the ON-period is ignored. For example, the sensor output is not used for reference position learning or sensor failure diagnosis. Since the position of the valve is detected from the sensor output taken in during the OFF-period of the power supply, the valve position can be accurately detected regardless of presence/absence of the power supply to the motor.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic diagram showing an intake controller for an internal combustion engine in a first embodiment of the present invention;

FIG. 2A is a cross section showing a fully closed position of an intake flow control valve in the first embodiment;

FIG. 2B is a cross section showing a fully open position of the intake flow control valve in the first embodiment;

FIG. 3 is a perspective view showing a valve unit (cartridge) in the first embodiment;

FIG. 4 is a cross section showing an intake vortex generating device in the first embodiment;

FIG. 5 is a block diagram showing an engine control system in the first embodiment;

FIG. 6 is a block diagram showing an H-bridge circuit and a microcomputer (ECU) in the first embodiment;

FIG. 7 is a flow chart showing a drive control of the H-bridge circuit by the ECU in the first embodiment;

FIG. 8 is a flow chart showing the drive control of the H-bridge circuit by ECU in the first embodiment;

FIG. 9 is a flow chart showing the drive control of the H-bridge circuit by ECU in the first embodiment;

FIGS. 10A and 10B are timing charts showing a power supply pattern to a motor and an AD taking-in timing of an output signal of a valve position sensor in the first embodiment;

FIG. 11 is a flow chart showing a reference position learning by the ECU in the first embodiment;

FIG. 12 is a flow chart showing the reference position learning by the ECU in the first embodiment;

FIG. 13 is a flow chart showing a reference position learning by the ECU in a second embodiment; and

FIG. 14 is a schematic diagram showing a conventional intake vortex generating device.

### DETAILED DESCRIPTION OF EMBODIMENTS

### First Embodiment

### Structure of First Embodiment

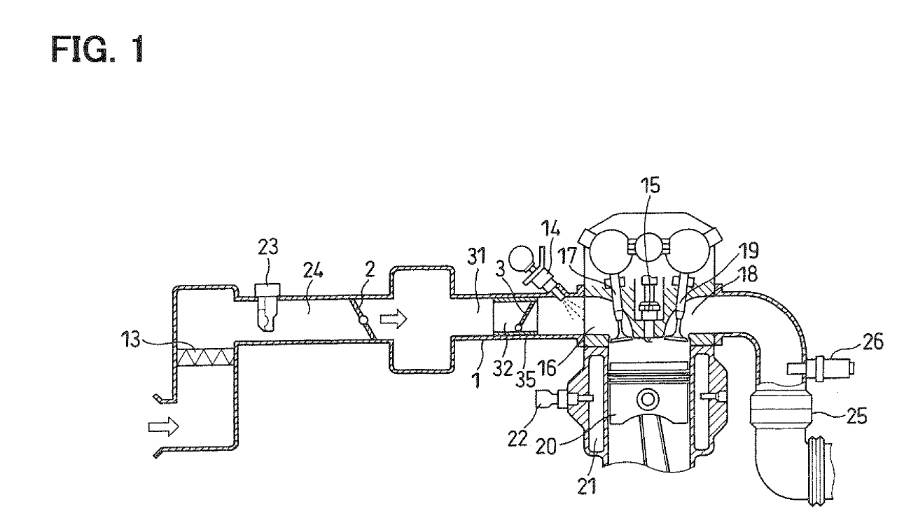

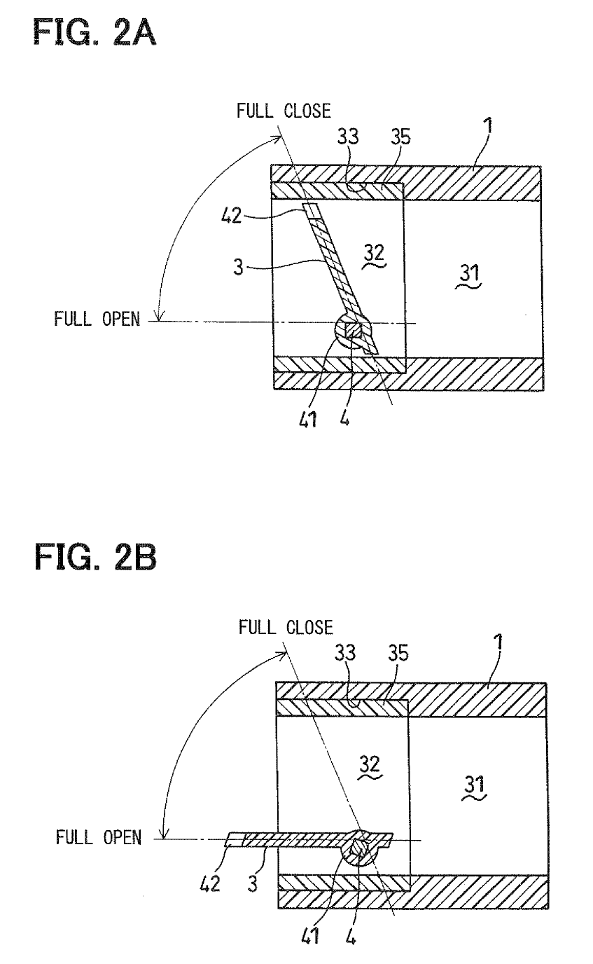

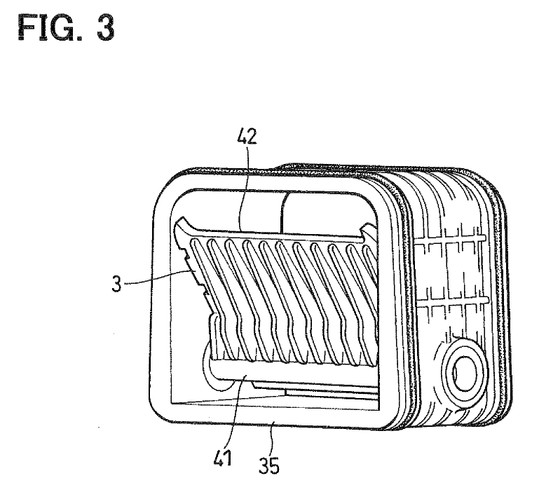

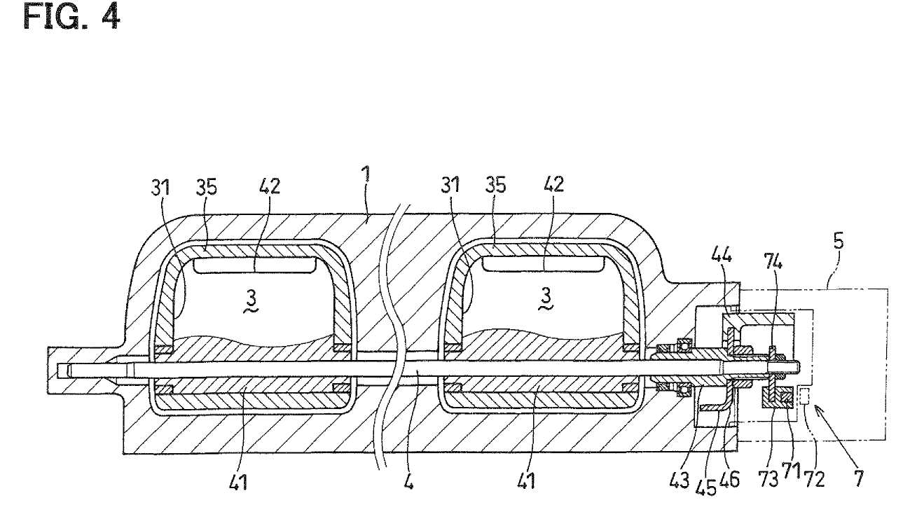

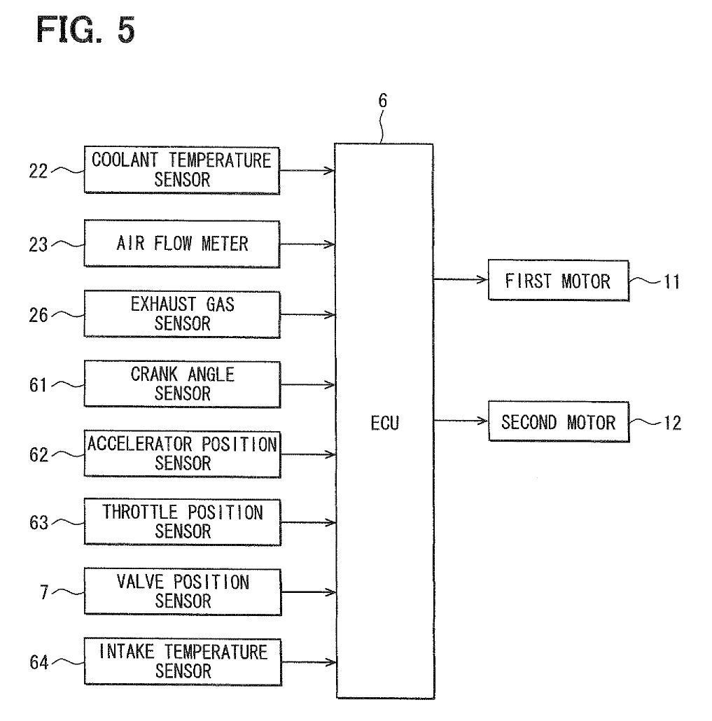

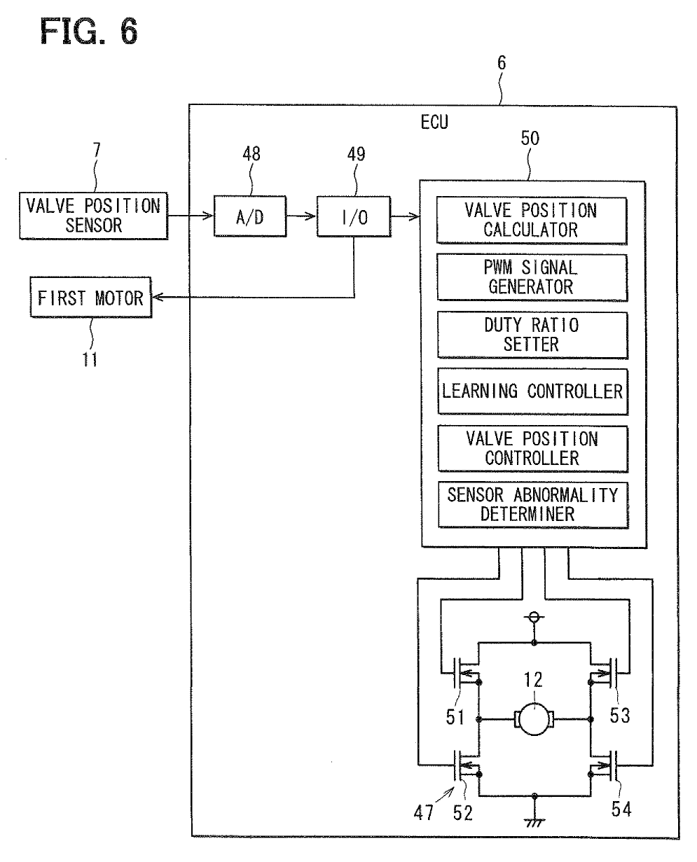

A first embodiment of the present invention will be explained with reference to FIGS. 1 to 12. FIG. 1 is a diagram showing an intake controller for an internal combustion engine. FIG. 2A is a cross sectional view showing a fully closed position of an intake flow control valve. FIG. 2B is a cross sectional view showing a fully open position of the intake flow control valve. FIG. 3 is a perspective view showing a valve unit (cartridge). FIG. 4 is a cross section view showing an intake vortex generating device. FIG. 5 is a block diagram showing an engine control system. FIG. 6 is a block diagram showing an H-bridge circuit and a microcomputer.

A controller for an internal combustion engine in the present embodiment is used as an intake controller (intake passage opening/closing device) for opening/closing an intake passage through which the intake air flows into a combustion chamber of each cylinder. The internal combustion engine has a plurality of cylinders, for example, four cylinders. The intake controller is provided with an electronic throttle controller controlling an intake air flow rate and an intake vortex generating device generating an intake vortex for promoting combustion of an air-fuel mixture in the combustion chamber of each cylinder.

The engine produces a thermal energy by burning in the combustion chamber a mixture of clean intake air filtered in a filter element 13 and fuel injected from an electromagnetic fuel injector 14. The engine is a four-cycle engine in which four strokes of an intake stroke, a compression stroke, a power stroke and an exhaust stroke are repeated periodically. The engine has a cylinder head connected air-tightly to a lower end of an intake manifold 1, a cylinder block forming the combustion chamber between the cylinder head and the cylinder block, and the like. An injector 14 is attached at the downstream portion of the intake manifold 1 (or cylinder head) for injecting fuel into an intake port of each cylinder at an optimal timing. The cylinder head is provided with a spark plug 15 attached thereto so that a tip portion thereof is exposed to the combustion chamber of each cylinder.

Each of a plurality of intake ports 16 formed in one side of the cylinder head is opened/closed by a poppet type of intake valve 17. Each of a plurality of exhaust ports 18 formed in the other side of the cylinder head is opened/closed by a poppet type of exhaust valve 19. A piston 20 connected through a connecting rod to a crank shaft is slidably supported in a cylinder bore formed inside the cylinder block. A coolant temperature sensor 22 is mounted in the cylinder block for detecting an engine coolant temperature cyclically supplied to a water jacket 21.

The intake pipe of the engine is a casing (intake duct and intake introduction duct) in which the intake passage is formed for supplying intake air to the combustion chamber of each cylinder. The intake pipe of the present embodiment is provided with an air flow meter 23 for detecting an intake air flow rate aspired into the combustion chamber of each cylinder. Further, one common intake passage (intake passage of the engine) 24 communicated with the combustion chamber of each cylinder is formed upstream of the intake manifold 1. The exhaust pipe of the engine is a casing (exhaust duct and exhaust discharge duct) in which the exhaust passage is formed for discharging an exhaust gas flowing out from the combustion chamber of each cylinder via an exhaust gas purifying device 25 to an outside. In the present embodiment, for example, a catalyst such as a three-way catalyst for purifying CO, HC, NOx and the like in the exhaust gas is adopted as the exhaust gas purifying device 25. The exhaust pipe of the present embodiment is provided with an exhaust gas sensor 26.

The electronic throttle controller of the present embodiment is a system for varying the intake air flow rate aspired into the combustion chamber of each cylinder in accordance with a throttle opening corresponding to a valve position of a throttle valve 2. The electronic throttle controller is comprised of a throttle body arranged in the intake pipe of the engine, a butterfly type of throttle valve 2 varying an intake air flow rate flowing through the intake pipe (common intake passage 24), a return spring (or default spring) urging the throttle valve 2 in the valve-closing direction (or in the valve-opening direction) and the like.

The throttle body is provided with an actuator for driving a shaft (rotational shaft) supporting and fixing the throttle valve 2 in the valve-opening direction (or in the valve-closing direction). The actuator includes a first motor 11 which generates a drive force upon receiving supply of power, a power transmission mechanism (for example, gear reduction mechanism) for transmitting the drive force of the first motor 11 to the shaft of the throttle valve 2, and the like. The first motor 11 for driving the throttle valve 2 is electrically connected to a battery mounted in a vehicle through a motor drive circuit which is electronically controlled by an electronic control unit (ECU) 6.

The intake vortex generating device of the present embodiment is installed in an engine room of the vehicle. The intake vortex generating device is a system which throttles each passage cross sectional area of a first and a second intake passages 31, 32 communicated with the combustion chamber to generate a longitudinal intake vortex (intake vortex: tumble flow) in the combustion chamber. The intake vortex generating device is incorporated in an intake system of the engine together with the electronic throttle controller. The intake vortex generating device is an intake passage opening/closing device of a multiple one-piece type (valve opening/closing device) in which a plurality of valve units are arranged in parallel with each other at constant intervals in an axial direction (rotational shaft direction) of a pin rod (rotational shaft or shaft) 4 inside the intake manifold 1 (housing storage chamber).

The intake vortex generating device is comprised of: the intake manifold 1 connected to the intake pipe of the engine downstream of the throttle body and the surge tank in the intake flow direction; a plurality of intake flow control valves (tumble control valve “TCV”) which are intake control valves controlling intake air flowing in an inside (the first and second intake passages 31, 32) of the intake manifold 1; a pin rod 4 press-fitted into an inside of the intake flow control valve 3 which is a valve body of TCV; an actuator which can integrally change valve positions (rotational angle) of the plurality of the TCVs through the pin rod 4; and ECU 6 for controlling the valve position of TCV in association with each system such as the electric throttle controller, an ignition device and a fuel injection device.

The intake manifold 1 of the present embodiment is the casing (intake introduction duct) which forms the plurality of the first intake passages (branch intake passage) 31 communicated with the combustion chamber of each cylinder in the engine. The first intake passages 31 in a square section and the housing storage chambers 33 in a square section respectively are formed inside the intake manifold 1 by the number corresponding to that of the cylinders. Each first intake passage 31 is connected to each intake port 16 of the cylinder head separately from each other. The housing 35 of the TCV is fitted and retained inside of each housing storage chamber 33.

Each of the plurality of the TCVs is comprised of the housing 35 stored in the housing storage chamber 33 of the intake manifold 1, the intake flow control valve 3 installed inside the housing 35 (second intake passage 32) in such a manner as to be capable of opening and closing therein, and the like. In the present embodiment, the housing 35 and the intake flow control valve 3 constitute the valve unit (cartridge) fitted and retained in the housing storage chamber 33 of the intake manifold 1. The intake manifold 1, the plurality of the housings 35 and the plurality of the intake flow control valves 3 are formed integrally by a resin material.

The plurality of the valve units include the plurality of the second intake passages 32, each being connected corresponding to each first intake passage 31 of the intake manifold 1 and corresponding to each intake port 16 of the cylinder head for each of the plurality of the housings 35. That is, the second intake passage 32 in a square section is formed inside of each housing 35. Each of the second intake passages 32 is arranged downstream of the first intake passage 31 in the intake flow direction, and is connected through each intake port 16 of the cylinder head to the combustion chamber of each cylinder separately from each other. Each intake flow control valve 3 is accommodated in each housing 35 in such a manner as to open and close therein.

Each of the plurality of the intake flow control valves 3 is a rotary valve which has a rotational center axis in a direction orthogonal to the axis direction (intake flow direction) of each housing 35 and is connected to one pin rod 4 in a skewer state. In the intake flow control valve 3, a rotational angle thereof (valve position) changes within a valve operable range from a fully open position where an opening area in each second intake passage 32 is maximized to a fully closed position where the opening area in each second intake passage 32 is minimized. In this way, the intake flow control valve 3 rotates relatively to each housing 35 to open/close each second intake passage 32. That is, the passage cross sectional area of each second intake passage 32 is thus throttled.

When the engine is in a cold state or only a small intake air flow rate is needed, the plurality of the intake flow control valves 3 are, as shown in FIG. 2A, made to be fully closed by the actuator, particularly the driving force of the motor. That is, each valve position of the plurality of the TCVs is controlled to be in a fully closed position of the valve. The fully closed position of the intake flow control valve 3 means a fully closed state where the intake flow control valve 3 fully closes the second intake passage 32. The fully closed position is a limit position in the other side of a possible operation range of the intake flow control valve 3, that is, a fully closed-side regulation position where a fully closed stopper portion of a stopper lever 45 fitted and fixed on the outer periphery of the joint shaft 4 bumps against a fully closed stopper (not shown) to prevent the intake flow control valve 3 from being furthermore rotated to the fully closed side.

The plurality of the intake flow control valves 3 are, as shown in FIG. 2B, made to be fully opened by the drive force of the motor at intermediate and high speed rotational regions or at intermediate and high load regions of the engine. That is, each valve position of the plurality of the TCVs is controlled to be in a fully open state (fully open position). The fully open position of the intake flow control valve 3 means a fully open state where the intake flow control valve 3 fully opens the second intake passage 32. The fully open position is a limit position in one side of the possible operation range of the intake flow control valve 3, that is, a fully open-side regulation position where a fully open stopper portion of the stopper lever 45 bumps against a fully open stopper to prevent the intake flow control valve 3 from being furthermore rotated to the fully open side. When power supply to the motor is stopped at engine stopping, each of the plurality of the intake flow control valves 3 is returned back to the fully open position (or state of an intermediate opening which is closed more slightly than the fully open position (intermediate position)) by an urging force of a spring, for example.

Each of the plurality of the valve units has a polygonal hole (square hole) penetrating in the rotational shaft direction of the pin rod 4 for each of the plurality of the intake flow control valves 3. The plurality of the intake flow control valves 3 have a cylindrical rotational shaft (valve shaft) 41 arranged to surround the circumference of the pin rod 4, each being formed of a sheet-shaped valve body extending toward one side (half side) in the diameter direction perpendicular to the rotational shaft direction from the valve shaft 41. In each of the plurality of the intake flow control valves 3, the valve shaft 41 constituting the rotational center is arranged in a position shifted to the half side (lower side in the figure) from the valve center portion of the intake flow control valve 3 in the valve surface direction perpendicular to the plate thickness direction of the intake flow control valve 3. Therefore, the intake flow control valve 3 is of a cantilever type valve. In the present embodiment, by cutting away a part (central portion) of an upper end surface of the intake flow control valve 3, that is, by cutting away the valve upper end surface at the opposite side to the valve shaft, a rectangular opening (notch portion or slit) 42 is formed for generating the tumble flow in the combustion chamber of each cylinder in the engine. The opening 42 may not be provided. In the present embodiment, by cutting away a part of each of the right and left side surfaces of the intake flow control valve 3, a sub-opening having an opening area smaller than that of the opening (primary opening) 42 may be formed.

The pin rod 4 is inserted inside of each polygonal hole formed for each of the intake flow control valves 3 by press-fitting. The pin rod 4 allows the respective valve shafts 41 of the intake flow control valves 3 to be connected in a skewer shape. As a result, the pin rod 4 is one drive shaft which can connect all the intake flow control valves 3 so as to move together. The pin rod 4 is a rotational shaft for changing the valve position of the plurality of the TCVs, and is press-fitted and fixed on an inner periphery of each polygonal hole provided in each of the plurality of the intake flow control valves 3. The pin rod 4 is a shaft in a polygonal section (angular steel shaft), having a cross section vertical to the rotational shaft direction which is formed in a polygonal shape (for example, square shape) and is formed integrally by a metallic material.

The cylindrical joint shaft 43 is fitted and retained on an outer periphery of the pin rod 4 at the other end side (actuator side) in the rotational shaft direction thereof in the present embodiment. The joint shaft 43 is a shaft in a cylindrical section, having a cross section vertical to the rotational shaft direction which is formed in a cylindrical shape and is formed integrally by a metallic material. The joint shaft 43 in the present embodiment is fitted and retained on the outer periphery of the pin rod 4 to connect a final reduction gear 44 of the actuator and the stopper lever 45 retaining and fixing the final reduction gear 44 to the pin rod 4.

The actuator in the present embodiment is comprised of an electric actuator including a second motor 12 generating a drive force, a power transmission mechanism transmitting the rotational motion of the motor shaft (motor shaft or output shaft) of the second motor 12 to the pin rod 4, and an actuator body 5 housing the second motor 12 and the power transmission mechanism therein. The power transmission mechanism is comprised of a gear reduction mechanism which reduces a rotational speed of the second motor 12 to acquire a predetermined reduction ratio and increases the drive force (motor torque) of the second motor 12. The gear reduction mechanism includes a motor gear fixed to the motor shaft of the second motor 12, an intermediate reduction gear meshing with the motor gear, and the final reduction gear 44 meshing with the intermediate reduction gear. The respective gears are rotatably accommodated in the actuator body 5, particularly the actuator case. A spring may be assembled in the pin rod 4 or the final reduction gear 44 for urging all the intake flow control valves 3 in the valve-opening direction or the valve-closing direction.

The final reduction gear 44 is integrally formed in an arc shape by a resin material. The stopper lever 45 is insert-molded inside the final reduction gear 44, being selectively engaged to a fully open stopper (fully open stopper screw) or a fully closed stopper (fully closed stopper screw) supported and fixed in the intake manifold 1. The stopper lever 45 includes a bent portion 46 which is bent in an L-shape. The fully open stopper portion engaged to the fully open stopper is provided at one side in the rotational direction (valve-opening direction) of the bent portion 46 of the stopper lever 45. When the fully open stopper portion of the stopper lever 45 bumps against the fully open stopper, the valve position of the TCV is regulated to be in a fully open state of valve opening (fully open position). The fully closed stopper portion engaged to the fully closed stopper is provided at the other side in the rotational direction (valve-closing direction) of the bent portion 46 of the stopper lever 45. When the fully closed stopper portion of the stopper lever 45 bumps against the fully closed stopper, the valve position of the TCV is regulated to be in a fully closed state of valve opening (fully closed position).

The second motor 12 is electrically connected to the battery mounted in a vehicle through the H-bridge circuit 47 which is electronically controlled by the ECU 6. The second motor 12 is a DC motor with a brush, which is comprised of a rotor (armature) integral with the motor shaft, a stator (field) arranged to be opposed to the outer periphery side of the rotor, and the like. The rotor of the second motor 12 has a core around which a coil is wound. The stator of the second motor 12 has a motor yoke (magnetic element) or a motor frame retaining a plurality of permanent magnets on its inner periphery. As an alternative to the DC motor with the brush, a brushless DC motor or an AC motor such as an induction motor or a synchronous motor may be adopted.

When the coil of the rotor is energized, the second motor 12 generating the drive force for driving the intake flow control valve 3 through the pin rod 4 is configured to be controlled (driven) through the H-bridge circuit 47 by the ECU 6. The ECU 6 is provided with the H-bridge circuit 47, an A/D conversion circuit 48, an input/output circuit (I/O port) 49, and the microcomputer 50. The H-bridge circuit 47 is formed by bridge-connecting four MOSFET 51 to 54, which are referred to as a first semiconductor switching element to a fourth semiconductor switching element hereinafter. Drains of the first and third semiconductor switching elements 51, 53 are connected to a plus side of the battery. Sources of the second and fourth semiconductor switching elements 52, 54 are connected to the ground (a minus side of the battery). The coil of the second motor 12 is connected to the midway of a current path which connects an intermediate point of a first conductive wire connecting the source of the first semiconductor switching element 51 and the drain of the second semiconductor switching element 52, and an intermediate point of a second conductive wire connecting the source of the third semiconductor switching element 53 and the drain of the fourth semiconductor switching element 54.

When an ignition switch is turned ON, the ECU 6 electronically controls the first motor 11 of the electronic throttle controller and the second motor 12 of the intake vortex generating device based upon the control programs or the control logic stored in the memory of the microcomputer 50. When the ignition switch is turned OFF, each engine control based upon the control programs or the control logic is compulsorily terminated. At engine stopping, by using the drive force of the second motor 12 or the urging force of the spring, the intake flow control valves 3 may be hold at an intermediate opening state (intermediate position) where the intake flow control valve 3 is closed (or open) slightly away in the valve-closing direction (or in the valve-opening direction) from the fully open position (or the fully closed position).

The sensor signals from the valve position sensor 7 for detecting a valve position of TCV, the coolant temperature sensor 22, the air flow meter 23, and the exhaust gas sensor (air-fuel ratio sensor or oxygen sensor) 26 for detecting a state of an exhaust gas (air-fuel ratio or the like) are A/D-converted by the A/D conversion circuit 48 and thereafter, inputted through the I/O port 49 to the microcomputer 50.

Furthermore, the sensor signals from a crank angle sensor 61 for detecting a rotational angle of the crank shaft of the engine, an accelerator pedal position sensor 62 for detecting a depressing amount (accelerator pedal position) of an accelerator pedal, a throttle position sensor 63 for detecting a valve position of the throttle valve 2 (throttle valve position), an intake temperature sensor 64 for detecting a temperature of intake air aspired into the combustion chamber of each cylinder, a battery voltage sensor for detecting a voltage value of the battery (battery voltage) as a power source of the motors 11 and 12, and a vehicle speed sensor for detecting a running speed (vehicle speed) of a vehicle are A/D-converted by the A/D conversion circuit 48 and thereafter, inputted through the I/O port 49 to the microcomputer 50.

The coolant temperature sensor 22, the air flow meter 23, the crank angle sensor 61, the accelerator position sensor 62, the throttle position sensor 63, the intake temperature sensor 64, the battery voltage sensor, and the vehicle speed sensor function as an operating condition detecting means for detecting an operating condition of the engine, an environment change detecting means for detecting a circumferential environment change of the second motor 12 (for example, change of a temperature, change of a battery voltage), and a running condition detecting means for detecting a running condition of a vehicle. Sensor signals from various sensors such as the coolant temperature sensor 22, the air flow meter 23, the crank angle sensor 61, the accelerator position sensor 62, the throttle position sensor 63, the intake temperature sensor 64, the battery voltage sensor, and the vehicle speed sensor are repeatedly read for each control period of the control program or the control logic stored in the memory of the microcomputer 50. The crank angle sensor 61 is comprised of a pickup coil for converting the rotational angle of the crank shaft of the engine into an electrical signal and outputs a NE pulse signal every 30° C.A.

The valve position sensor 7 is a rotational angle detecting device of a non-contact type which includes a magnet 71 fixed at the other end in the rotational shaft direction of the pin rod 4, a Hall IC 72 having a magnetic detecting element of a non-contact type for detecting the magnetic flux emitted from the magnet 71, and a division type yoke (not shown) for concentrating the magnetic flux emitted from the magnet 71 on the hole IC 72. The valve position sensor 7 detects a valve position of TCV by using output change characteristics of the Hall IC 72 relative to the rotational angle of the pin rod 4, particularly the magnet 71. That is, the valve position sensor 7 detects the valve position of TCV based upon a change of the magnetic flux density passing through a magnetic flux detection gap formed between a pair of opposing division yokes (magnetic bodies), that is, the Hall IC 72.

The magnet 71 is a permanent magnet which generates a magnetic force for a long time period and emits the magnetic flux toward the Hall IC 72 and the division type yoke. The magnet 71 is retained and is fixed by clamping means such as an adhesive to a magnet rotor 73 rotating relatively to the actuator case and the Hall IC 72. The magnet rotor 73 retaining the magnet 71 is formed integrally with the magnet 71 by a resin material and insert-molds a sensor fixing lever 74 therein.

The magnet 71 and the magnet rotor 73 retaining the magnet 71 are retained and fixed in the sensor fixing lever 74 fitted and retained at the other end in the rotational shaft direction of the pin rod 4 in such a manner as to rotate with rotation of the plurality of the intake flow control valves 3 as a detection object and the pin rod 4. In place of the magnet 7, an electromagnet for generating a magnetic force subject to supply of power may be used. The magnet rotor 73 retaining the magnet 71 may be attached to the stopper lever 45.

The Hall IC 72 is arranged in the magnetic flux detection gap formed between the pair of the opposing yokes to form a magnetic circuit with the magnet 71. The hole IC 71 is retained and fixed in the actuator body 5, particularly a sensor mounting portion of the actuator case. The Hall IC 72 is an IC (integrated circuit) formed by uniting a hole element with an amplifying circuit for amplifying the output of the hole element. The Hall element constitutes the magnetic detection element of a non-contact type of which output changes in accordance with the magnetic flux density passing through the magnetic flux detection gap (the magnetic flux density passing through the Hall IC 72). The Hall IC 72 outputs a voltage signal in accordance with the magnetic flux density passing through the magnetic flux detection gap. Thereby, a sensor output voltage is outputted from the hole IC 72 toward ECU 6. The output signal from the Hall IC 72 (valve position signal or analogue signal) is repeatedly taken in through the A/D conversion circuit 48 in each predetermined sampling period to be described later.

The ECU 6 serves as valve position detecting means for measuring the present position of the intake flow control valve 3 based upon a valve position signal outputted from the valve position sensor 7. In place of the valve position sensor 7, a rotor position detecting means for detecting a rotor position of the second motor 12 may be provided. The ECU 6 serves as a current detecting means for detecting a current value of motor drive current flowing in the second motor 12 of the intake vortex generating device. In place of the current detecting means of the ECU 6, a current sensor may be provided for detecting the current value of the motor drive current flowing in the second motor 12.

The A/D conversion circuit 48 is sampling means for taking in the valve position signal outputted from the valve position sensor 7 in a predetermined sampling period. The A/D conversion circuit 48 sets the AD taking-in timing of the output signal of the valve position sensor 7 to an integral multiple (integral multiple such as one time, twice, three times or more) of the power supply start timing to the second motor 12 in a generation period of a PWM signal (PWM period) to be described later. The A/D conversion circuit 48 takes in the valve position signal outputted from the valve position sensor 7 only during an OFF-period of power supply in the PWM period.

In the present embodiment, for setting the AD taking-in timing of the output signal of the valve position sensor 7 to the integral multiple of the power supply start timing to the second motor 12, the AD taking-in timing of the output signal of the valve position sensor 7 is synchronized with the power supply start timing to the second motor 12 in the PWM period. The A/D conversion circuit 48 sets a period of the sampling (sampling period) for converting (A/D conversion) an analogue signal as the output signal of the valve position sensor 7 to a digital signal to the integral multiple (integral multiple such as one time, twice, three times or more) of the PWM period. In the present embodiment, the sampling period is synchronized with the PWM period. The AD conversion circuit 48 takes in the valve position signal outputted from the valve position sensor 7 only during the OFF-period of the power supply.

The microcomputer 50 is provided with a CPU for performing control processing or calculation processing, a memory device (volatile memory such as SRAM and DRAM and involatile memory such as EPROM, EEPROM or flash memory) for storing control programs or control logic and various data, a power source circuit, a timer and the like. The microcomputer 50 serves as rotational speed detecting means for detecting an engine rotational speed (engine speed: NE) by measuring an interval time of NE pulse signals outputted from the crank angle sensor 61.

The microcomputer 50 is a motor control device for driving the H-bridge circuit 47 and includes: a valve position calculating means which calculates an actual valve position of TCV from an A/D conversion value of the output signal of the valve position sensor 7 taken in from the A/D conversion circuit 48 at every predetermined sampling timing; a PWM signal generating means (pulse signal generating means) which generates a PWM signal of a predetermined duty ratio in a predetermined period (PWM period); a duty ratio setting means which sets a duty ratio of the PWM signal based upon a deviation between the actual valve position and a target valve position of TCV; a learning control means which finds a reference position of the control from a valve position signal outputted from the valve position sensor 7 when the plurality of the intake flow control valves 3 are in a reference position to perform the reference position learning for storing the reference position of the control as a reference position learning value; a valve position control means which controls the valve position of TCV based upon the reference position learning value; and a sensor abnormality determining means which carries out sensor failure diagnosis for determining whether or not the valve position sensor 7 or the like is abnormal.

### Control Method of First Embodiment

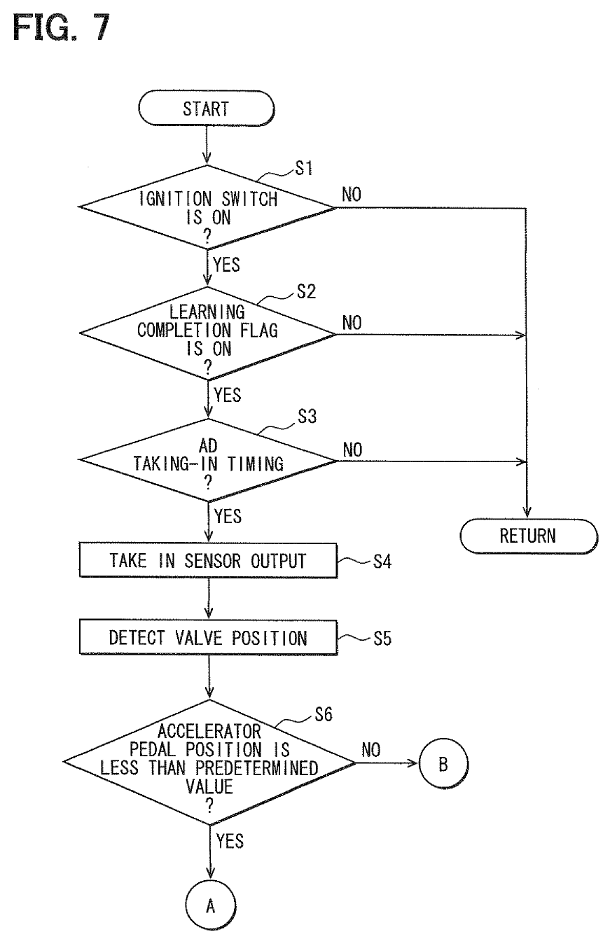

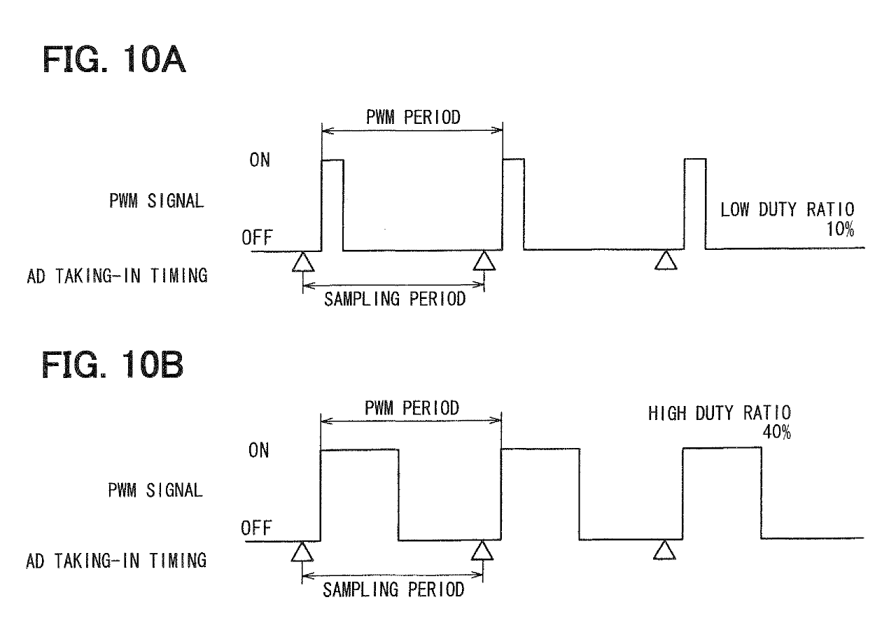

The method of controlling the intake controller (intake vortex generating device) for the internal combustion engine in the present embodiment will be explained with reference to FIGS. 1 to 12. FIGS. 7 to 9 are flow charts each showing a drive control of the H-bridge circuit by the ECU 6. FIG. 10 is a timing chart showing a power supply pattern to the motor and an AD taking-in timing of the output signal of the valve position sensor.

When the control routine in FIG. 7 is started, it is determined whether or not the ignition switch is turned ON in step S1. When this determination result is NO, the control routine in FIG. 7 ends. When this determination result in step S1 is YES, it is determined whether or not a learning completion flag representing that the reference position learning is completed is ON in step S2. When this determination result is NO, the control routine in FIG. 7 ends. When this determination result in step S2 is YES, it is determined whether or not there occurs a sampling period for A/D conversion of the valve position signal (hereinafter, referred to as the output signal of the valve position sensor 7) outputted from the Hall IC 72 of the valve position sensor 7 in step S3. The sampling period represents the AD taking-in timing of the output signal of the valve position sensor 7. When this determination result is NO, the control routine in FIG. 7 ends.

In the present embodiment, as shown in FIGS. 10A and 10B, the sampling period of the output signal of the valve position sensor 7 is synchronized with the generation period of the pulse signal. The generation period of the pulse signal corresponds to a PMW period. The PWM signal is an abbreviation of a Pulse Width Modulation signal. That is, the power supply start timing to the second motor 12 in the PWM period is synchronized with the AD taking-in timing of the output signal of the valve position sensor 7 and the output signal of the valve position sensor 7 is taken in only during the OFF-period of the power supply. The sampling period can not be used at a duty ratio of 100%, but the AD taking-in timing of the output signal of the valve position sensor 7 is set to the timing where the sampling period can be used even at a duty ratio as high as possible. For example, in a case where the PWM period is 10×α (μsec), the counter is activated from the power supply start timing to the second motor 12 in the PWM period. When the counter counts nine (when a predetermined time 9×α (μsec) has elapsed from the power supply start timing), the output signal of the valve position sensor 7 may be taken in to the A/D conversion circuit 48. The AD taking-in timing of the output signal of the valve position sensor 7 may be set immediately before the power supply start timing to the second motor 12 in the next PWM period.

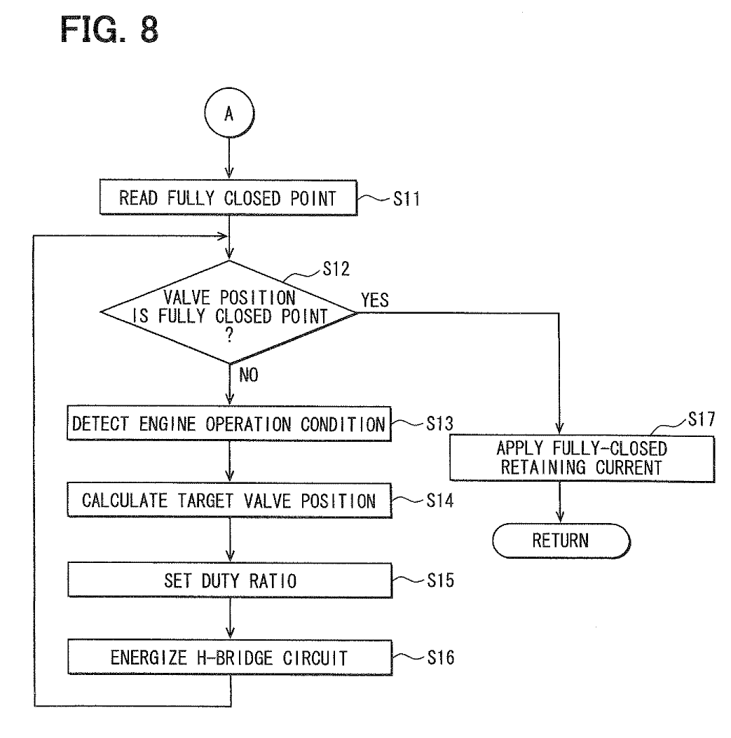

When this determination result in step S3 is YES, the output signal of the valve position sensor 7 is taken in to the A/D conversion circuit 48 in step S4. Next, the actual valve position of TCV is detected (calculated) based upon the A/D conversion value of the output signal of the valve position sensor 7 which is converted from an analogue signal to a digital signal at the A/D conversion circuit 48 in step S5. This process corresponds to a valve position calculating means. Then, it is determined whether or not the accelerator pedal is depressed. That is, it is determined whether or not an accelerator pedal position calculated from an accelerator pedal position signal outputted from the accelerator pedal position sensor 62 is less than a predetermined value in step S6. When this determination result is YES, the process goes to the control routine in FIG. 8, wherein the reference position learning value (fully closed position learning value) stored in the memory of the microcomputer 50 is read as a fully closed point of the control in step S1.

It is determined whether or not the actual valve position of TCV is the fully closed point of the control in step S12. When this determination result is NO, an operation condition of the engine is detected (calculated) based upon the output signals outputted from various sensors in step S13. The target valve position of TCV is calculated based upon the operating condition of the engine in step S14. When the engine is in a cold state and needs only a small quantity of intake air, that is, at engine starting or at idling, the fully closed point of the control is set as the target valve position. A duty ratio of the pulse signal given to the H-bridge circuit 47 (particularly, base of the third semiconductor switching element 53) is set based upon a deviation between the actual valve position and the target valve position (fully closed point of the control) of TCV. That is, a drive duty ratio (DUTY ratio) is set (calculated) for operating the plurality of the intake flow control valves 3 in the valve-closing direction in step S15.

The pulse signal in accordance with the calculated DUTY ratio is given to the H-bridge circuit 47, particularly, to the third semiconductor switching element 53 in step S16. This process corresponds to a pulse signal generating means. Thereafter, the determination process in step S12 is repeated. At this point, the PWM signal of a predetermined duty ratio controlled based upon the deviation between the actual valve position and the target valve position (fully closed point of the control) of TCV is generated in a predetermined period. This process corresponds to a pulse signal generating means.

The duty ratio of the PWM signal given to the H-bridge circuit 47, particularly, to the base of the third semiconductor switching element 53 is, as shown in FIGS. 10A and 10B, a ratio (ON/OFF ratio) between an ON-period of the power supply to the coil of the second motor 12 and an OFF-period of the power supply in a generation period of the PWM signal (PWM period) so that the actual valve position of TCV is equal to the target valve position (fully closed point of the control).

As the duty ratio of the PWM signal outputted from the microcomputer 50 to the H-bridge circuit 47, particularly, to the base of the third semiconductor switching element 53 increases, the motor drive current flowing in the coil of the second motor 12 also increases. FIG. 10A shows a pattern in which the duty ratio of the PWM signal is a low DUTY ratio. FIG. 10B shows a pattern in which the duty ratio of the PWM signal is a high DUTY ratio. The low DUTY ratio and the high DUTY ratio are fixed values adapted for each vehicle and engine.

At the time of fully closing the plurality of the intake flow control valves 3, the first semiconductor switching element 51 is ON, the second semiconductor switching element 52 is OFF, the third semiconductor switching element 53 is OFF/ON and the fourth semiconductor switching element 54 is ON/OFF. In consequence, the third and fourth semiconductor switching elements 53, 54 of the H-bridge circuit 47 are PWM-controlled. Particularly, the PWM signal which is PWM-controlled based upon the deviation between the actual valve position and the target valve position (fully closed point of the control) of TCV is inputted to the base of the third semiconductor switching element 53 of the H-bridge circuit 47. In consequence, a motor applied voltage in accordance with the duty ratio of the PWM signal is applied to the coil of the second motor 12 of the intake vortex generating device and the motor drive current in the valve-closing direction (plus direction) flows in the coil of the second motor 12.

When the determination result in step S12 is YES, the plurality of the intake flow control valves 3 are retained at a fully closed state (fully closed position) in which the second intake passage 32 is fully closed. That is, the plurality of the intake flow control valves 3 are retained in the fully closed position by using a drive force of the second motor 12. At this time, the fully-closed retaining current in accordance with the duty ratio of the PWM signal flows in the coil of the second motor 12 in the intake vortex generating device in step S17. Thereafter, the control routine in FIG. 8 ends.

Thereby, the plurality of the intake flow control valves 3 are retained at the fully closed position by using the drive force of the second motor 12. In this case, almost all the intake flow which has flowed from the plurality of the first intake passages 31 to the plurality of the second intake passages 32 flows as below. The each flow passes through a clearance (opening 42) between a passage wall surface of a housing upper wall portion in the housing 35 and a valve upper end surface of the intake flow control valve 3. Then, the intake flow is introduced from each outlet port of the plurality of the second intake passages 32 to an upper layer portion of the intake port 16, and flows along a ceiling wall surface of the upper layer portion of the intake port 16. The intake flow flowing along the ceiling wall surface of the upper layer portion of the intake port 16 is supplied from a port opening of the intake port 16 into the combustion chamber. At this time, since a tumble flow is generated in the combustion chamber in each cylinder of the engine, the combustion efficiency improves in the combustion chamber at engine starting or at idling to improve fuel economy, exhaust emissions (for example, HC reduction effect) or the like.

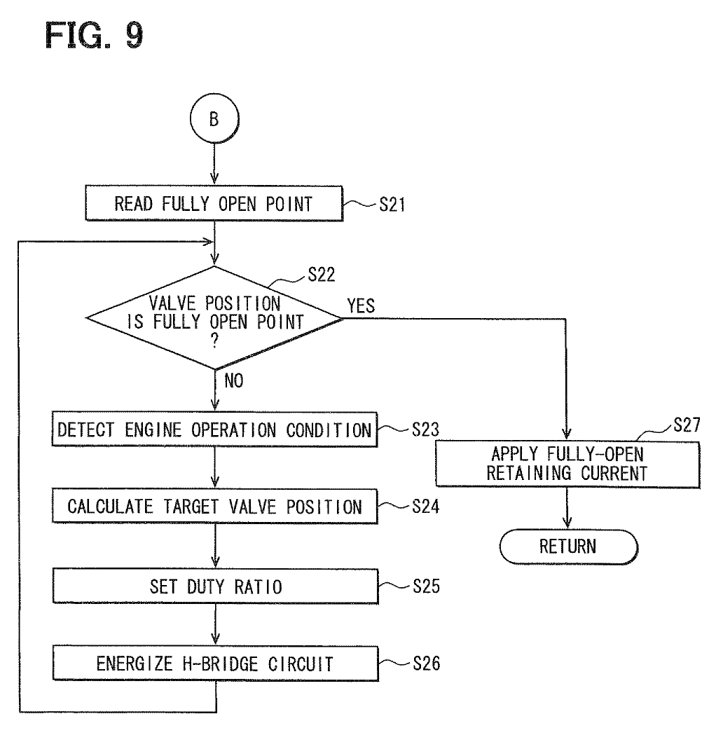

When the determination result in step S6 is YES, the process goes to the control routine in FIG. 9, wherein the reference position learning value (fully open position learning value) stored in the memory of the microcomputer 50 is read as a fully open point of the control in step S21. Then, it is determined whether or not the actual valve position of TCV is the fully open point of the control in step S22. When this determination result is NO, an operation state of (engine condition) of the engine is detected (calculated) based upon the output signals outputted from various sensors in step S23. The target valve position of TCV is calculated based upon the operating condition of the engine in step S24. When the engine is in a normal operating condition, the fully open point of the control is set as the target valve position. The duty ratio of the PWM signal given to the H-bridge circuit 47, particularly, to the base of the second semiconductor switching element 52 is set based upon the deviation between the actual valve position and the target valve position (fully open point of the control) of TCV. That is, the drive duty ratio (DUTY ratio) is set (calculated) for operating the plurality of the intake flow control valves 3 in the valve-opening direction in step S25.

The PWM signal in accordance with the calculated DUTY ratio is given to the H-bridge circuit 47, particularly, to the base of the second semiconductor switching element 52 in step S26. This process corresponds to a pulse signal generating means. Thereafter, the procedure goes back to the determination process in step S22. At this point, in the PWM signal generating means of the microcomputer 50, the PWM signal of the predetermined duty ratio which is controlled based upon the deviation between the actual valve position and the target valve position (fully open point of the control) of TCV is generated in a predetermined period. This also corresponds to the pulse signal generating means.

The duty ratio of the PWM signal given to the H-bridge circuit 47, particularly, to the base of the second semiconductor switching element 52 is a ratio (ON/OFF ratio) between an ON-period of the power supply to the coil of the second motor 12 and an OFF-period of the power supply to the coil of the second motor 12 so that the actual valve position of TCV is equal to the target valve position (fully open point of the control). As the duty ratio of the PWM signal outputted from the microcomputer 50 to the H-bridge circuit 47, particularly, to the base of the second semiconductor switching element 52 increases, the motor drive current flowing in the coil of the second motor 12 also increases.

At the time of fully opening the plurality of the intake flow control valves 3, the first semiconductor switching element 51 is ON, the second semiconductor switching element 52 is ON/OFF, the third semiconductor switching element 53 is OFF/ON and the fourth semiconductor switching element 54 is OFF. In consequence, the second and third semiconductor switching elements 52, 53 of the H-bridge circuit 47 are PWM-controlled. Particularly, the PWM signal which is PWM-controlled based upon the deviation between the actual valve position and the target valve position (fully open point of the control) of TCV is inputted to the base of the second semiconductor switching element 52 of the H-bridge circuit 47. In consequence, the motor applied voltage in accordance with the duty ratio of the PWM signal is applied to the coil of the second motor 12 and the motor drive current in the valve-open direction (reverse direction to the valve-closing direction) flows in the coil of the second motor 12.

When the determination result in step S22 is YES, the plurality of the intake flow control valves 3 are retained at a fully open state (fully open position) in which the second intake passage 32 is fully opened. That is, the plurality of the intake flow control valves 3 are retained at the fully open position by using the drive force of the second motor 12. At this time, the fully open retaining current in accordance with the duty ratio of the PWM signal flows in the coil of the second motor 12 in step S27. Thereafter, the control routine in FIG. 9 ends.

Thereby, the plurality of the intake flow control valves 3 are retained at the fully open position by using the drive force of the second motor 12. In this case, the intake flow which has flowed from the plurality of the first intake passages 31 to the plurality of the second intake passages 32 passes straight through the plurality of the second intake passages 32. And then, the intake flow is introduced from each outlet port of the plurality of the second intake passages 32 into the intake port 16. The intake flow which has flowed through the intake port 16 is supplied from the port opening of the intake port 16 into the combustion chamber. At this time, the longitudinal vortex (tumble flow) is not generated in the combustion chamber in each cylinder of the engine.

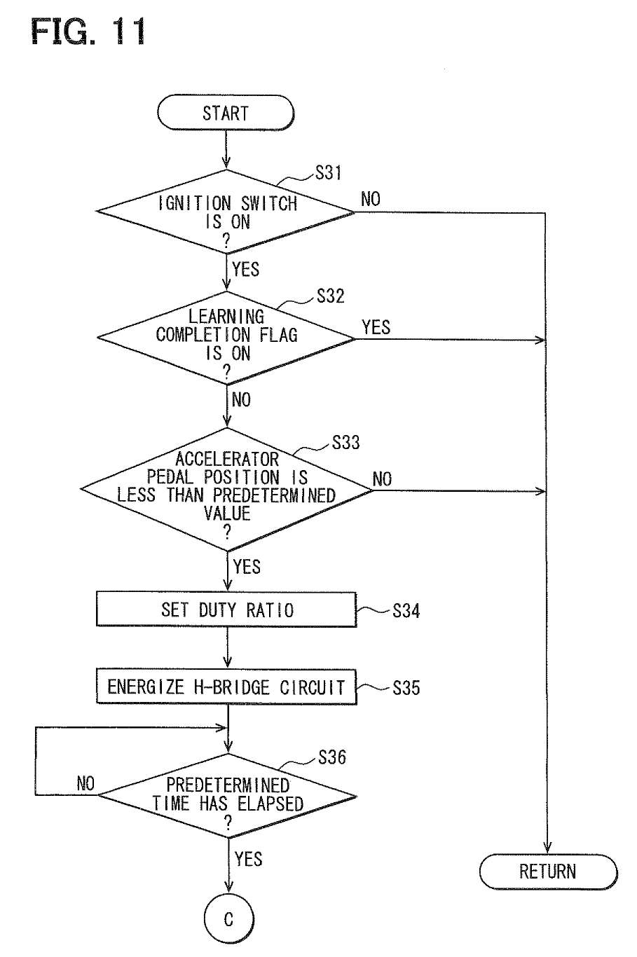

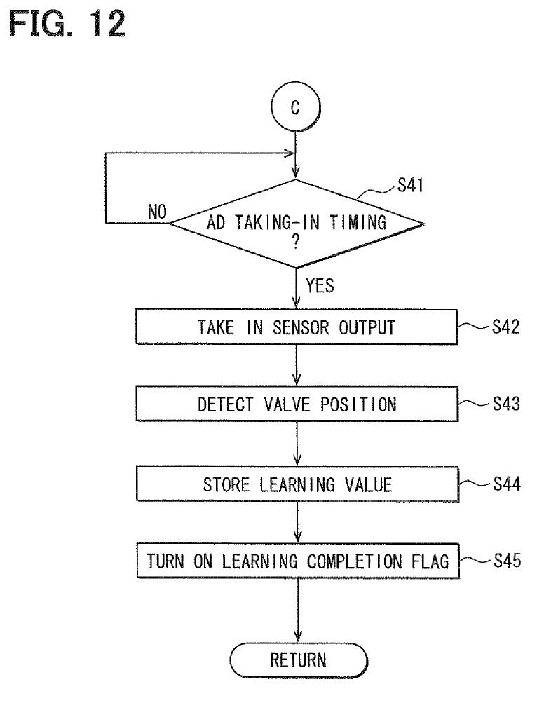

FIGS. 11 and 12 are flow charts each showing the reference position learning process by the ECU 6. First, it is determined whether or not the ignition switch is turned ON in step S31. When this determination result is NO, the control routine in FIG. 11 ends.

When this determination result in step S31 is YES, it is determined whether or not a learning completion flag is ON in step S32, which represents that the reference position learning has been completed. When this determination result is YES, the control routine in FIG. 11 ends. When the determination result in step S32 is NO, it is determined whether or not the accelerator pedal is depressed. That is, it is determined whether or not an accelerator pedal position calculated from an accelerator pedal position signal outputted from the accelerator pedal position sensor 62 is less than a predetermined value in step S33. When this determination result is NO, the control routine in FIG. 11 ends.

When this determination result in step S33 is YES, the second motor 12 is energized so that the plurality of the intake flow control valves 3 are brought into a limit position (fully closed position) of a possible operating range. That is, a fully closed stopper portion of the stopper lever 45 retained and fixed to the outer periphery of the pin rod 4 is brought into contact with the fully closed stopper. The microcomputer 50 sets (calculates) a drive duty ratio (DUTY ratio) for operating the plurality of the intake flow control valves 3 in the valve-closing direction in step S34.

The microcomputer 50 provides the PWM signal in accordance with the calculated DUTY ratio to the H-bridge circuit 47. At the time of fully closing the plurality of the intake flow control valves 3, the first semiconductor switching element 51 is ON, the second semiconductor switching element 52 is OFF, the third semiconductor switching element 53 is OFF/ON, and the fourth semiconductor switching element 54 is ON/OFF. In consequence, the third and fourth semiconductor switching elements 53, 54 of the H-bridge circuit 47 are PWM-controlled in step S35. Then, it is determined whether or not a predetermined time has elapsed from the power supply start timing to the coil of the second motor 12 in step S36. When the determination result is NO, the determination process in step S36 is repeated.

When this determination result in step S36 is YES, the process goes to the control routine in FIG. 12, wherein it is determined that the plurality of the intake flow control valves 3 are bumped against the limit position (fully closed position) within the possible operating range. That is, it is determined that the plurality of the intake flow control valves 3 come up to the fully closed position to determine whether or not there occurs the sampling period for A/D conversion of the output signal of the valve position sensor 7 (AD taking-in timing of the output signal of the valve position sensor 7) in step S41. When the determination result is NO, the determination process in step S41 is repeated. When this determination result in step S41 is YES, the output signal of the valve position sensor 7 is taken into the A/D conversion circuit 48 in step S42. The actual valve position of TCV is detected (calculated) based upon an A/D conversion value of the output signal of the valve position sensor 7 which is converted from an analogue signal to a digital signal at the A/D conversion circuit 48 in step S43. This process corresponds to a valve position calculating means.

The determination result in step S36 is YES and the plurality of the intake flow control valves 3 are bumped against the limit position (fully closed position) within the possible operating range. That is, since it can be determined that the plurality of the intake flow control valves 3 come up to the fully closed position, the actual valve position (the present valve position) of TCV is defined as a reference position. A reference position of the control (fully closed point of the control) is found from the output signal of the valve position sensor 7 when the plurality of the intake flow control valves 3 is in the reference position (fully closed position). The fully closed point of the control is stored as a reference position learning value (fully closed position learning value) in the memory of the microcomputer 50 in step S44. This process corresponds to a learning control means. Next, the learning completion flag is turned ON in step S45. Thereafter, the control routine in FIG. 12 ends. The learning completion flag is turned OFF when the ignition switch is turned OFF.

In a case of performing the fully open position learning as the reference position learning, as is different from the above PWM control, the drive force is generated in the second motor 12 so as to bump the plurality of the intake flow control valves 3 against a limit position (fully open position) of the possible operating range. That is, the microcomputer 50 sets (calculates) a drive duty ratio (DUTY ratio) for operating the plurality of the intake flow control valves 3 in the valve-opening direction. The microcomputer 50 provides the PWM signal in accordance with the calculated DUTY ratio to the H-bridge circuit 47. At the time of fully opening the plurality of the intake flow control valves 3, the first semiconductor switching element 51 is OFF/ON, the second semiconductor switching element 52 is ON/OFF, the third semiconductor switching element 53 is ON, and the fourth semiconductor switching element 54 is OFF. In consequence, the first and second semiconductor switching elements 51, 52 of the H-bridge circuit 47 are PWM-controlled.

A reference position of the control (fully open point of the control) is found from the output signal of the valve position sensor 7 when the plurality of the intake flow control valves 3 is in the reference position (fully open position). The fully open point of the control is stored as a reference position learning value (fully open position learning value) in the memory of the microcomputer 50, which corresponds to the learning control means. Here, in the intake vortex generating device, the reference position learning value (fully closed position learning value or fully open position learning value) based upon the output signal of the valve position sensor 7 may be shifted to a position more closed or more open than the actual fully closed position (fully closed position or fully open position) due to an individual difference or an assembly error of the Hall IC 72 of the valve position sensor 7. In this case, in the valve position control during engine operating, when the target valve position is set to the fully closed point of the control or the fully open point of the control, even after the fully closed stopper portion or the fully open stopper portion of the stopper lever 45 bumps against the fully closed stopper or the fully open stopper, the plurality of the intake flow control valve 3 continues to be driven to the closed side or the open side by the valve position control means.

However, after the fully closed stopper portion or the fully open stopper portion of the stopper lever 45 bumps against the fully closed stopper or the fully open stopper, even if the plurality of the intake flow control valve 3 continues to be driven to the closed side or the open side by the valve position control means, the deviation between the actual throttle position and the target throttle position is not reduced any more. Therefore, the drive duty ratio of the second motor 12 is in the order of 10% to 40% in a steady condition, but the drive duty ratio of the second motor 12 is rapidly increased to the duty ratio of 100%, possibly damaging the coil of the motor with heat. Therefore, the microcomputer 50 is configured as follows for preventing a failure of the second motor 12 in the intake vortex generating device. When the state where the DUTY ratio of the second motor 12 is 100% continuously occurs for more than a predetermined time, a sensor abnormality diagnosis flag (FDIAG) is ON and the abnormality (failure) of the valve position sensor 7 is stored in the memory of the microcomputer 50, a warning lamp such as an indicator lamp is turned ON or a diagnosis output such as notice of sounds or the like is outputted.

### Advantages of First Embodiment

As described above, in the intake controller (intake vortex generating device) for the internal combustion engine in the present embodiment, cantilever type valves are adopted as the plurality of the intake flow control valves 3. The ECU 6, for coping with the intake pulsation torque in the first and second intake passages 31 and 32, supplies the motor application voltage or the motor drive current by which the plurality of the intake flow control valves 3 can be retained in a state of bumping the plurality of the intake flow control valves 3 against the limit position of the possible operating range (fully closed position or fully open position), to the coil of the second motor 12. At this time, as shown in FIGS. 10A and 10B, the AD taking-in timing of the output signal of the valve position sensor 7 is set to the integral multiple of the power supply start timing to the second motor 12 in the PWM period of the PWM signal provided to the H-bridge circuit 47, particularly, to the base of the third semiconductor switching element 53. Further, the valve position signal outputted from the valve position sensor 7 is taken in only during the OFF-period of the power supply in the PWM period.

In the present embodiment, for setting the AD taking-in timing of the output signal of the valve position sensor 7 to the integral multiple of the power supply start timing to the second motor 12, the AD taking-in timing of the output signal of the valve position sensor 7 is synchronized with the power supply start timing to the second motor 12 in the PWM period. The sampling period is set to the integral multiple of the PWM period for carrying out A/D conversion of the output signal of the valve position sensor 7. In the present embodiment, the sampling period is synchronized with PWM period. The valve position signal outputted from the valve position sensor 7 is taken in only during the OFF-period of the power supply in the PWM period.

In consequence, the actual valve position of TCV is detected (calculated) from the A/D conversion value of the output signal in the valve position sensor 7 taken in during the OFF-period of the power supply in the PWM period where the output change of the valve position sensor 7 having the Hall IC 72 is small. Therefore, the actual valve position of TCV can be accurately detected regardless of presence/absence of the power supply to the coil in the second motor 12. In consequence, since the reference position learning (fully closed position learning or the fully open position learning) can be carried out based upon the A/D conversion value of the output signal in the valve position sensor 7 taken in during the OFF-period of the power supply in the PWM period, an erroneous learning of the reference position of the control (fully closed point of the control or fully open point of the control) can be prevented. The sensor failure diagnosis can be performed based upon the A/D conversion value of the output signal in the valve position sensor 7 taken in only during the OFF-period of the power supply in the PWM period. This can prevent the event that the sensor abnormality diagnosis flag (FDIAG) is ON by erroneously diagnosing that the normal valve position sensor 7, particularly the Hall IC 72 is abnormal (defective).

### Second Embodiment

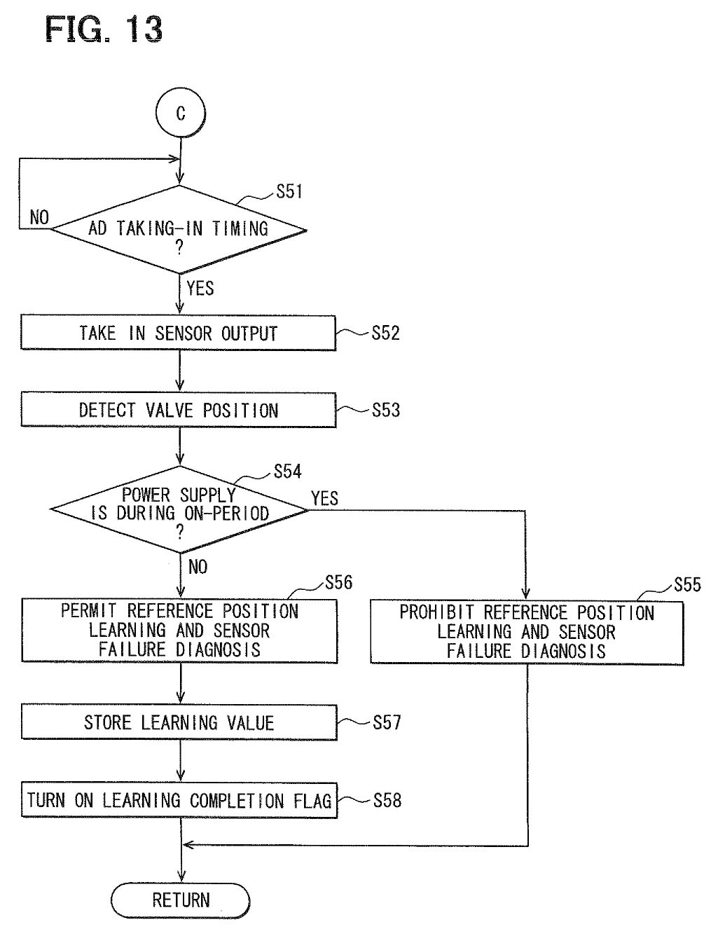

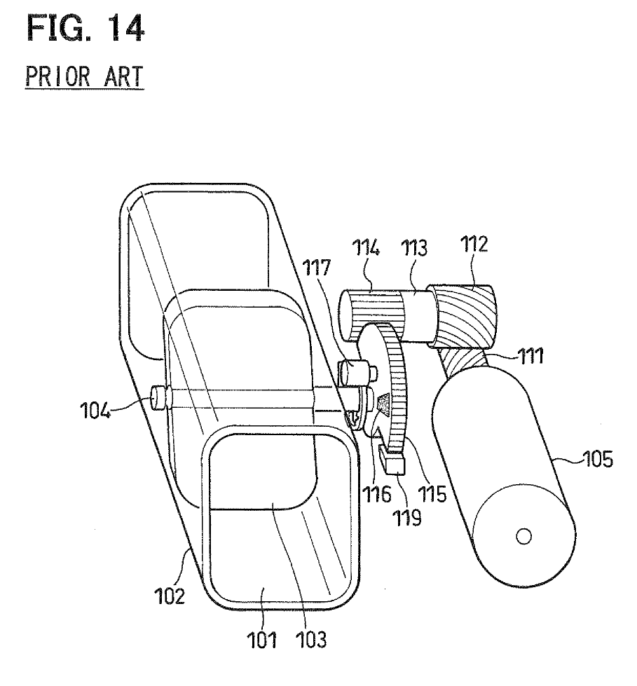

FIG. 13 shows a second embodiment of the present embodiment and is a flow chart showing a reference position learning process. The control routine in FIG. 13 is executed when the determination result in step S36 is YES.

When this determination result in step S36 is YES, it is determined whether or not there occurs the sampling period (AD taking-in timing of the output signal of the valve position sensor 7) for A/D conversion of the output signal of the valve position sensor 7 in step S51. When the determination result is NO, the determination process in step S51 is repeated. When this determination result in step S51 is YES, the output signal of the valve position sensor 7 is taken in the A/D conversion circuit 48 in step S52. In step S53, the actual valve position of TCV is detected (calculated) based upon the A/D conversion value of the output signal of the valve position sensor 7 which is converted from an analogue signal to a digital signal at the A/D conversion circuit 48. This process corresponds to a valve position calculating means.

It is determined whether or not the power supply is during an ON-period in the PWM period of the PWM signal provided to the H-bridge circuit 47, particularly, to the base of the third semiconductor switching element 53 in step S54. When this determination result is YES, it is prohibited to perform the reference position learning and the sensor failure diagnosis based upon the A/D conversion value of the output signal of the valve position sensor 7 taken in during the ON period of the power supply in the PWM period in step S55. Thereafter, the control routine in FIG. 13 ends. In consequence, the reference position learning value (fully close position learning value) is not stored in the memory of the microcomputer 50, and the learning completion flag remains in OFF. When this determination result in step S54 is NO, it is permitted to perform the reference position learning and the sensor failure diagnosis based upon the A/D conversion value of the output signal in the valve position sensor 7 taken in during the OFF-period of the power supply in the PWM period in step S56.

The determination result in step S36 is YES and the plurality of the intake flow control valves 3 are bumped against the limit position (fully closed position) within the possible operating range. That is, since it can be determined that the plurality of the intake flow control valves 3 come up to the fully closed position, the actual valve position (the present valve position) of TCV is defined as a reference position. A reference position of the control (fully closed point of the control) is found from the output signal of the valve position sensor 7 when the plurality of the intake flow control valves 3 is in the reference position (fully closed position). The fully closed point of the control is stored as a reference position learning value (fully closed position learning value) in the memory of the microcomputer 50 in step S57, which corresponds to a learning control means. Next, the learning completion flag is turned ON in step S58. Thereafter, the control routine in FIG. 13 ends. The learning completion flag is turned OFF when the ignition switch is turned OFF.

As described above, in the intake controller (intake vortex generating device) for the internal combustion engine in the present embodiment, the motor application voltage or the motor drive current are supplied to the coil of the second motor 12 by which the plurality of the intake flow control valves 3 can be retained in a state of being bumped against the limit position of the possible operating range (fully closed position or fully open position). During this period, the ECU 6 is operated to ignore the A/D conversion value of the output signal of the valve position sensor 7 taken in during the ON period of the power supply in the PWM period of the PWM signal provided to the H-bridge circuit 47, particularly, to the base of the third semiconductor switching element 53. Therefore, when the power continues to be supplied to the second motor 12 even after driving the plurality of the intake flow control valves 3 to the reference position (fully closed position or the fully open position), the magnetic field changes in the circumference of the valve position sensor 7 having the Hall IC 72 to change the output of the valve position sensor 7. Even in occurrence of this event, the A/D conversion value of the output signal of the valve position sensor 7 taken in during the ON period of the power supply in the PWM period is ignored. In consequence, the actual valve position of TCV is detected (calculated) from the A/D conversion value of the output signal in the valve position sensor 7 taken in during the OFF-period of the power supply in the PWM period where the output change of the valve position sensor 7 having the hole IC 72 is small. Therefore, the actual valve position of TCV can be accurately detected regardless of presence/absence of the power supply to the coil in the second motor 12.

The event of ignoring the A/D conversion value of the output signal in the valve position sensor 7 taken in during the ON-period of the power supply in the PWM period is to prohibit execution of the reference position learning based upon the A/D conversion value of the output signal in the valve position sensor 7 taken in during the ON-period of the power supply in the PWM period. In this case, it is permitted only to execute the reference position learning based upon the A/D conversion value of the output signal in the valve position sensor 7 taken in during the OFF-period of the power supply in the PWM period, thereby making it possible to prevent the erroneous learning of the reference position of the control. The event of ignoring the A/D conversion value of the output signal in the valve position sensor 7 taken in during the ON-period of the power supply in the PWM period is to prohibit execution of the sensor failure diagnosis based upon the A/D conversion value of the output signal in the valve position sensor 7 taken in during the ON-period of the power supply in the PWM period. In this case, it is permitted only to perform the sensor failure diagnosis based upon the A/D conversion value of the output signal in the valve position sensor 7 taken in during the OFF-period of the power supply in the PWM period, thereby making it possible to prevent the normal valve position sensor 7 from being in error determined to be abnormal (defective).

### [Modification]

In the present embodiment, the intake controller for the internal combustion engine is applied to the intake controller for the internal combustion engine provided with the intake vortex generating device, but the intake controller may be applied to an electronic throttle controller for an internal combustion engine controlling a flow quantity of intake air by opening/closing an intake passage for the internal combustion engine or an intake variable controller for an internal combustion engine changing a passage length or a passage cross sectional area of an intake passage by opening/closing the intake passage for the internal combustion engine.

In the present embodiment, the intake vortex generating device is constructed to be capable of generating the longitudinal intake vortex (tumble flow) for promoting combustion of a mixture in the combustion chamber of each cylinder in the engine, but the intake vortex generating device may be constructed to be capable of generating a lateral intake vortex (swirl flow) for promoting combustion of a mixture in the combustion chamber of each cylinder in the engine. Further, the intake vortex generating device may be constructed to be capable of generating a squish vortex for promoting combustion of the engine.

In the present embodiment, the actuator for driving the valve shaft 41 of the intake flow control valve 3 is formed of the second motor 12 and the power transmission mechanism (for example, gear reduction mechanism), but the actuator for driving the shaft of the valve may be formed of the motor only. The shaft of the valve may be directly driven without through the pin rod 4. A valve urging means such as a spring for urging the valve in the valve-opening direction or in the valve-closing direction may be or may not be provided.

As the intake control valve including the valve installed in the intake passage formed inside the casing such as the intake pipe or the intake manifold to control intake air aspired into the combustion chamber for the internal combustion engine, in place of the TCV (tumble flow control valve) in the present embodiment, there may be provided an intake flow quantity control valve including a throttle valve installed in the intake passage formed inside the throttle body to control intake air aspired into the combustion chamber for the internal combustion chamber, or an intake flow quantity control valve including an idle rotational speed control valve installed in the intake passage formed inside the housing to control a flow quantity of intake air bypassing the throttle valve.

Further, as the intake control valve formed of the casing (or housing) and the intake flow control valve, an intake passage opening/closing valve, an intake passage switching valve or an intake pressure control valve may be used in place of the intake flow control valve or the intake flow quantity control valve. The intake control valve may be applied to an intake flow control valve such as a tumble flow control valve or a swirl flow control valve, or an intake variable valve changing a passage length or a passage cross sectional area of the intake passage for the internal combustion engine. As the intake flow control valve, in place of the rotary valve, a poppet type valve may be used. In this case, a motion-direction converting mechanism is provided in the actuator. A diesel engine may be used as the internal combustion engine. Further, not only the multi-cylinder engine but also a single-cylinder engine may be used as the internal combustion engine.

The present embodiment adopts a multiple one-piece valve opening/closing device (intake passage opening/closing device) where a plurality of valve units are arranged at constant intervals in the rotational shaft direction of the pin rod 4 inside the intake manifold 1 as the casing, each valve unit (cartridge) assembling one intake flow control valve 3 inside one housing 35 for the intake flow control valve 3 to open or close therein. However, there may be adopted a multiple one-piece valve opening/closing device (intake passage opening/closing device) where a plurality of valves are directly arranged at constant intervals in the rotational shaft direction of the shaft inside the casing (another intake pipe, engine head cover or cylinder head). In this case, the housing 35 can be abolished.

The intake control valve is not limited to the multiple one-piece intake control valve, but if the valve is arranged in the intake passage for the internal combustion engine, one intake control valve may be used. The present embodiment, as the intake control valve driven by the motor as the power source, adopts the cantilever intake flow control valve 3 in which the rotational shaft (valve shaft) constituting the rotational center is arranged in a position shifted to the half side in the valve surface direction perpendicular to the plate thickness direction of the intake flow control valve 3. However, the present embodiment may adopt, as the intake control valve driven by the motor as the power source, a shaft-centered type intake control valve (butterfly type valve) in which the rotational shaft (valve shaft) constituting the rotational center is arranged in a position substantially in the central portion in the valve surface direction perpendicular to the plate thickness direction of the intake flow control valve 3.

The drive duty ratio of the second motor 12 or the duty ratio of the PWM signal may be corrected in accordance with environment changes in the circumference of the intake vortex generating device (system) including the second motor 12, such as a battery voltage signal outputted from a battery voltage sensor and a coolant temperature signal outputted from the coolant temperature sensor 22 (or an environment temperature in the circumference of the second motor 12 (for example, engine room temperature or a coil temperature of the second motor 12)). In this case, as the battery voltage increases, the drive duty ratio of the second motor 12 or the duty ratio of the PWM signal is set (corrected) to the larger value. As the coolant temperature (or environment temperature in the circumference of the second motor 12) increases, the drive duty ratio of the second motor 12 or the duty ratio of the PWM signal is set (corrected) to the larger value.

At the time of fully closing the plurality of the intake flow control valves 3, for reducing the impact sound due to bumping the stopper lever 45 against the fully closed stopper, the deceleration control may be performed for reducing the operating speed of the plurality of the intake flow control valves 3 at a stage where the plurality of the intake flow control valves 3 reach to an intermediate position immediately before the reference position of the control (fully closed point of the control) learned by the reference position learning. At the time of fully opening the plurality of the intake flow control valves 3, for reducing the impact sound due to bumping the stopper lever 45 against the fully open stopper, the deceleration control may be performed for reducing the operating speed of the plurality of the intake flow control valves 3 at a stage where the plurality of the intake flow control valves 3 reach to an intermediate position immediately before the reference position of the control (fully open point of the control) learned by the reference position learning. While only the selected embodiments have been chosen to illustrate the present invention, it will be apparent to those skilled in the art from this disclosure that various changes and modifications can be made therein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. An intake controller for an internal combustion engine comprising:
a duct for defining an intake passage communicated with a combustion chamber of the internal combustion engine;
a valve arranged in the intake passage;
a motor generating a drive force driving a rotational shaft of the valve on receiving a power supply;
a sensor including a non-contact magnetic detecting element for detecting magnetic flux emitted from a magnet fixed to the rotational shaft of the valve to generate output in accordance with a position of the valve; and
a control unit for taking in the output of the sensor to detect the position of the valve and changing a ratio between an ON-period of power supply for supplying power to the motor and an OFF-period of the power supply for stopping the power supply to the motor in a generation period of a pulse signal so that the position of the valve is equal to a target position, wherein
the control unit sets a taking-in timing of the output of the sensor close to an integral multiple of a power supply start timing to the motor and takes in the output of the sensor only during the OFF-period of the power supply.

2. An intake controller for an internal combustion engine according to claim 1, wherein
the taking-in timing of the output of the sensor is synchronized with the power supply start timing to the motor, whereby the control units sets the taking-in timing of the output of the sensor close to the integral multiple of the power supply start timing to the motor by means of.

3. An intake controller for an internal combustion engine according to claim 1, wherein
the output of the sensor is taken in immediately before the power supply start timing to the motor, whereby the control units sets the taking-in timing of the output of the sensor close to the integral multiple of the power supply start timing to the motor.

4. An intake controller for an internal combustion engine according to claim 1, wherein
the control unit includes:
a sampling means which takes in the output of the sensor in a predetermined period;
a valve position calculating means which calculates an actual position of the valve based on the output of the sensor taken in by the sampling means;
a pulse signal generating means which generates a pulse signal of a predetermined duty ratio in a predetermined period; and
duty ratio setting means which sets a duty ratio of the pulse signal based upon a deviation between the actual position and the target position of the valve.

5. An intake controller for an internal combustion engine according to claim 4, wherein
the sampling means is configured in such a manner that a period of sampling the output of the sensor for converting the output from an analogue signal to a digital signal is set close to the integral multiple of the generation period of the pulse signal or is synchronized with the generation period of the pulse signal.

6. An intake controller for an internal combustion engine according to claim 1 wherein
the control unit includes:
a learning control means which finds a reference position of the control from the output of the sensor when the valve is in a reference position to performing a reference position learning in which the reference position of the control is stored as a reference position learning value; and
a valve position control means which controls the position of the valve based upon the reference position learning value.

7. An intake controller for an internal combustion engine according to claim 1, wherein
the control unit includes a sensor abnormality determining means which performs a sensor failure diagnosis for determining whether or not the sensor is abnormal.

8. An intake controller for an internal combustion engine comprising:
a duct for defining an intake passage communicated with a combustion chamber of the internal combustion engine;
a valve arranged in the intake passage;
a motor generating a drive force driving a rotational shaft of the valve on receiving a power supply;
a sensor including a non-contact magnetic detecting element for detecting magnetic flux emitted from a magnet fixed to the rotational shaft of the valve to generate output in accordance with a position of the valve; and
a control unit for taking in the output of the sensor to detect the position of the valve and changing a ratio between an ON-period of power supply for supplying power to the motor and an OFF-period of the power supply for stopping the power supply to the motor in a generation period of a pulse signal so that the position of the valve is equal to a target position, wherein
the control unit ignores the output of the sensor taken in during the ON-period of the power supply.

9. An intake controller for an internal combustion engine according to claim 8, wherein
the control unit makes the motor generate the drive force for the valve to bump against a limit position within a possible operating range of the valve.

10. An intake controller for an internal combustion engine according to claim 8, wherein
the control unit includes:
a sampling means which takes in the output of the sensor in a predetermined period;
a valve position calculating means which calculates an actual position of the valve based on the output of the sensor taken in by the sampling means;
a pulse signal generating means which generates a pulse signal of a predetermined duty ratio in a predetermined period; and
a duty ratio setting means which sets a duty ratio of the pulse signal based upon a deviation between the actual position and the target position of the valve.

11. An intake controller for an internal combustion engine according to claim 8 wherein
the control unit includes:
a learning control means which finds a reference position of the control from the output of the sensor when the valve is in a reference position to performing a reference position learning in which the reference position of the control is stored as a reference position learning value; and
a valve position control means which controls the position of the valve based upon the reference position learning value, wherein
the reference position learning is prohibited based upon the output of the sensor taken in during the ON-period of the power supply, whereby the control unit ignores the output of the sensor taken in during the ON-period of the power supply.

12. An intake controller for an internal combustion engine according to claim 8, wherein
the control unit includes:
a sensor abnormality determining means which performs a sensor failure diagnosis for determining whether or not the sensor is abnormal, wherein
the sensor failure diagnosis is prohibited based upon the output of the sensor taken in during the ON-period of the power supply, whereby the control unit ignores the output of the sensor taken in during the ON-period of the power supply.

13. An intake controller for an internal combustion engine according to claim 1, wherein
the control unit includes:
an H-bridge circuit including four switching elements connected in an H-bridge shape to the motor;
a pulse width modulation signal generating means which generates a pulse width modulation signal of a predetermined duty ratio in a predetermined period;
a sampling means which takes in the output of the sensor in a predetermined period;
a valve position calculating means which calculates an actual position of the valve based on the output of the sensor taken in by the sampling means; and
a duty ratio setting means which sets a duty ratio of the pulse width modulation signal in such a manner that the position of the valve agrees with the target position.

14. An intake controller for an internal combustion engine according to claim 1, wherein
the valve includes an intake flow control valve generating an intake vortex in the combustion chamber of the internal combustion engine.

15. An intake controller for an internal combustion engine according to claim 1, wherein
the valve includes a cantilever valve of which rotational shaft is shifted to one side in a valve surface direction perpendicular to the plate thickness direction of the valve.
